(19) United States
(12) Patent Application Publication
(10) Pub. No.: US 2011/0281130 A1
(43) Pub. Date: Nov. 17, 2011

(54) AQUEOUS POLYMER DISPERSION OBTAINED FROM A VINYLAROMATIC COMPOUND, CONJUGATED ALIPHATIC DIENE AND ETHYLENICALLY UNSATURATED ACID

(75) Inventors: Elitsa Evstatieva, Mannheim (DE); Dirk Lawrenz, Hassloch (DE)

(73) Assignee: BASF SE, Ludwigshafen (DE)

(21) Appl. No.: 13/145,364

(22) PCT Filed: Feb. 15, 2010
(86) PCT No.: PCT/EP2010/051833

§ 371 Date: Jul. 20, 2011

(30) Foreign Application Priority Data
Feb. 19, 2009 (EP) 09153187.1

(51) Int. Cl. B32B 29/00; D06M 15/233; C09D 147/00; D06M 15/263; C08L 47/00; C09J 147/00

(52) U.S. Cl. 428/537.5; 524/822; 524/556; 252/8.83; 428/532

(57) ABSTRACT

An arylcyclohexene-free or low-arylcyclohexene aqueous polymer dispersion and processes for the preparation thereof by free radical emulsion polymerization from at least three different monomer types are described. A monomeric vinylaromatic compound, a monomeric conjugated aliphatic diene and a monomeric ethylenically unsaturated acid are copolymerized in an aqueous medium in the presence of a mercaptoalkylcarboxylic acid ester of a C₂- to C₄-carboxylic acid and without alkyl mercaptan as a molecular weight regulator. The polymer dispersion can be used as a binder, adhesive, size for fibers, for the production of coverings or for the preparation of paper coating slips.

The invention relates to arylcyclohexene-free or low-arylcyclohexene aqueous polymer dispersions having a content of less than 90 ppm of arylcyclohexene compounds and processes for the preparation of the polymer dispersions by free radical emulsion polymerization from at least three different monomer types. A monomeric vinylaromatic compound, a monomeric conjugated aliphatic diene and a monomeric ethylenically unsaturated acid are copolymerized in an aqueous medium in the presence of a mercaptoalkylcarboxylic acid ester of a C₂- to C₄-carboxylic acid and without alkyl mercaptan as a molecular weight regulator. The invention also relates to the use of the polymer dispersions as a binder, adhesive, size for fibers, for the production of coverings or for the preparation of paper coating slips.

Aqueous polymer dispersions obtained from a vinylaromatic compound, conjugated aliphatic diene and ethylenically unsaturated acid have a variety of fields of use. Thus, for example, binders for paper coating slips based on copolylmers of vinylaromatic compounds, such as, for example, styrene, aliphatic dienes, such as, for example, 1,3-butadiene, and an ethylenically unsaturated acid, such as, for example, acrylic acid or methacrylic acid, are known. In the preparation of the polymers by free radical polymerization, molecular weight regulators or chain-transfer agents are used for establishing a molecular weight suitable for the respective field of use. The most effective and frequently used molecular weight regulators include alkyl mercaptan, i.e. alkanes substituted by a thiol group, such as, for example, tert-dodecyl mercaptan (TDMC). These substances have the advantage that, in addition to the properties for regulating the molecular weight of the polymers, they additionally lead to good performance characteristics of the paper coating slips. In particular, polymeric binders having a high binding power and paper coating slips comprising polymeric binders and having a good surface strength, for example, a good dry pick resistance and a good wet pick resistance, are desired. TDMC meets these requirements but has the disadvantage of an unpleasant odor. This may prove to be troublesome during the preparation and also in the end product. Alternative molecular weight regulators based on alkyl esters of mercaptoalkylcarboxylic acids are more advantageous in terms of odor than alkyl mercaptans but are not always satisfactory in every respect in the performance characteristics.

U.S. Pat. No. 5,354,800 describes a process for the preparation of copolymer dispersions which can be used, inter alia, as binders in paper coating slips. The preparation is effected by polymerization of conjugated diene monomer, a further ethylenically unsaturated monomer and an ethylenically unsaturated carboxylic acid monomer in the presence of a combination of a hydrophilic chain-transfer agent and a hydrophobic chain-transfer agent. Inter alia, alkyl mercaptans and mercaptoalkyl esters of alkanecarboxylic acids are mentioned as hydrophobic chain-transfer agents.

With the use of molecular weight regulators based on mercaptoalkyl esters of alkanecarboxylic acids in the copolymerization of vinylaromatics and conjugated, ethylenically unsaturated dienes, the formation of arylcyclohexenes as undesired by-products may occur. Thus, for example in the copolymerization of styrene and 1,3-butadiene, considerable amounts of undesired 4-phenylcyclohexene may form.

It is the object of the invention to provide aqueous polymer dispersions based on copolymers of vinylaromatics and conjugated aliphatic dienes, it being necessary for the dispersions to have as neutral an odor as possible, as good performance characteristics as possible as binders in paper coating slips and as low an arylcyclohexene content as possible in comparison with dispersions prepared using alkyl mercaptans.

The object is achieved, according to the invention, by an arylcyclohexene-free or low-arylcyclohexene aqueous polymer dispersion, which can be prepared by free radical emulsion polymerization from at least three different monomer types (A) to (C),

(A) at least one monomeric vinylaromatic compound,
(B) at least one monomeric conjugated aliphatic diene and
(C) at least one monomeric ethylenically unsaturated acid
being copolymerized in an aqueous medium,
the copolymerization of the monomers being effected in the presence of at least one molecular weight regulator,
at least one mercaptoalkylcarboxylic acid ester of a C₂- to C₄-carboxylic acid being used as the molecular weight regulator,
no or substantially no alky mercaptan being used as the molecular weight regulator and the content of arylcyclohexene compounds in the aqueous polymer dispersion being less than 90 ppm.

Arylcyclohexenes are organic compounds which have an aryl group, and the aryl group is substituted by at least one cyclohexene group and optionally by further groups. An example is 4-phenylcyclohexene. Low-arylcyclohexene means that the aqueous polymer dispersion comprises less than 90 ppm, in particular less than 80 ppm, of arylcyclohexene, preferably less than 90 ppm of 4-phenylcyclohexene, in particular less than 80 ppm of 4-phenylcyclohexene.

Preferably,

(A) from 19.8 to 80 parts by weight of at least one vinylaromatic compound,
(B) from 19.8 to 80 parts by weight of at least one conjugated aliphatic diene,
(C) from 0.1 to 15 parts by weight of at least one ethylenically unsaturated acid and
(D) from 0 to 20 parts by weight of at least one further monoethylenically unsaturated monomer differing from the monomers (A) to (C)
are used, the sum of the parts by weight of the monomers (A) to (D) being 100.

The aqueous polymer dispersions are obtainable, for example, by using monomer mixtures comprising

(A) from 19.8 to 80, preferably from 25 to 70, parts by weight of styrene and/or methylstyrene,
(B) from 19.8 to 80, preferably from 25 to 70, parts by weight of 1,3-butadiene and/or isoprene,
(C) from 0.1 to 15 parts by weight of at least one ethylenically unsaturated acid which is selected from one or more compounds of the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, vinylphosphonic acid and salts of these acids and
(D) from 0 to 20 parts by weight, preferably from 0.1 to 15 parts by weight, of at least one other monoethylenically unsaturated monomer which is selected from C₁- to C₁₈-alkyl esters of acrylic acid and C₁- to C₁₈-alkyl esters of methacrylic acid
in the emulsion polymerization, the sum of the parts by weight of the monomers (A) to (D) being 100.

Suitable monomers of group (A) are vinylaromatic compounds, e.g. styrene, α-methylstyrene and/or vinyltoluene. From this group of monomers, styrene is preferably used. 100 parts by weight of the monomer mixtures used altogether in the polymerization comprise, for example, from 19.8 to 80 parts by weight and preferably from 25 to 70 parts by weight of at least one monomer of group (A).

Monomers of group (B) are, for example, 1,3-butadiene, isoprene, 1,3-pentadiene, 1,3-dimethylbutadiene and cyclopentadiene. From this group of monomers, 1,3-butadiene and/or isoprene are preferably used. 100 parts by weight of the monomer mixtures which are used altogether in the emulsion polymerization comprise, for example, from 19.8 to 80 parts by weight, preferably from 25 to 70 parts by weight and in particular from 25 to 60 parts by weight of at least one monomer of group (B).

Monomers of group (C) are, for example, ethylenically unsaturated carboxylic acids, ethylenically unsaturated sulfonic acids and vinylphosphonic acid. α,β-Monoethylenically unsaturated mono- and dicarboxylic acids having 3 to 6 carbon atoms in the molecule are preferably used as the ethylenically unsaturated carboxylic acids. Examples of these are acrylic acid, methacrylic acid, itaconic acid, maleic acid, fumaric acid, crotonic acid, vinylacetic acid and vinyllactic acid. Suitable ethylenically unsaturated sulfonic acids are, for example, vinylsulfonic acid, styrenesulfonic acid, acrylamidomethylpropanesulfonic acid, sulfopropyl acrylate and sulfopropyl methacrylate. Acrylic acid and methacrylic acid are particularly preferred, in particular acrylic acid.

The monomers of group (C) which comprise acid groups may be used in the polymerization in the form of the free acids and in a form partly or completely neutralized with suitable bases. Sodium hydroxide solution, potassium hydroxide solution or ammonia is preferably used as a neutralizing agent. 100 parts by weight of the monomer mixtures which are used in the emulsion polymerization comprise, for example, from 0.1 to 15 parts by weight, preferably from 0.1 to 10 parts by weight or from 1 to 8 parts by weight of at least one monomer of group (C).

Monomer combinations in which the vinyl aromatic compound (A) is selected from styrene, methylstyrene and the mixture thereof, the conjugated aliphatic diene (B) selected from 1,3-butadiene, isoprene and the mixture thereof and the ethylenically unsaturated acid (C) is selected from one or more compounds of the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, vinylphosphonic acid and salts of these acids are preferred.

Suitable monomers of group (D) are other monoethylenically unsaturated compounds. Examples of these are ethylenically unsaturated carboxamides, such as, in particular, acrylamide and methacrylamide, ethylenically unsaturated carbonitriles, such as, in particular, acrylonitrile and methacrylonitrile, vinyl esters of saturated C₁- to C₁₈-carboxylic acids, preferably vinyl acetate, and esters of acrylic acid and of methacrylic acid with monohydric C₁- to C₁₈-alcohols, such as methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, sec-butyl acrylate, sec-butyl methacrylate, tert-butyl acrylate, tert-butyl methacrylate, pentyl acrylates, pentyl methacrylates, 2-ethylhexyl acrylate, 2-ethylhexyl methacrylate, allyl esters of saturated carboxylic acids, vinyl ethers, vinyl ketones, dialkyl esters of ethylenically unsaturated carboxylic acids, N-vinylpyrrolidone, N-vinylpyrrolidine, N-vinylformamide, N,N-dialkylaminoalkylacrylamides, N,N-dialkylaminoalkylmethacrylamides, N,N-dialkylaminoalkyl acrylates, N,N-dialkylaminoalkyl methacrylates, vinyl chloride and vinylidene chloride. This group of monomers is, if appropriate, used for modifying the polymers. 100 parts by weight of the monomer mixtures used in the emulsion polymerization comprise, for example, from 0 to 20 parts by weight or from 0.1 to 15 parts by weight and in particular from 0.5 to 10 parts by weight of at least one monomer of group (D).

In an embodiment of the invention, monomers of group (D) which are used are those whose copolymerization leads to a further reduction of the content of arylcyclohexene. In particular, C₁- to C₁₈-alkyl esters of acrylic acid and C₁- to C₁₈-alkyl esters of methacrylic acid, used in amounts of, for example, 0.1-15 parts by weight, are suitable.

In order to modify the properties of the polymers, the emulsion polymerization is carried out in the presence of at least one chain-transfer agent. Substantially no alkyl mercaptan is used here, i.e. alkyl mercaptans are not used at all or in any case are not used in amounts influencing the odor properties of the polymer dispersion.

At least one mercaptoalkylcarboxylic acid ester of a C₂- to C₄-carboxylic acid is used as the molecular weight regulator. The parent carboxylic acids are acetic acid, propionic acid, isobutyric acid or n-butyric acid, preferably propionic acid. The mercaptoalkyl groups may be linear, branched or cyclic hydrocarbon radicals having at least one SH group and for example, up to 18 carbon atoms. Compounds of the formula

R¹—C(═O)—O—R²—SH

where R¹ is an alkyl group having 1 to 3 carbon atoms and R² is a divalent alkylene group having 1 to 18 carbon atoms, are preferred. 2-Mercaptoethyl propionate is particularly preferably used as the molecular weight regulator.

Examples of further chain-transfer agents which, if appropriate, can be concomitantly used are organic compounds which comprise sulfur in bound form, such as thiodiglycol, ethylthioethanol, di-n-butyl sulfide di-n-octyl sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thiourea. Further chain-transfer agents are aldehydes, such as formaldehyde, acetaldehyde and propionaldehyde, organic acids, such as formic acid, sodium formate or ammonium formate, alcohols such as, in particular, isopropanol, and phosphorus compounds, such as sodium hypophosphite.

The amount of molecular weight regulator is, for example, from 0.01 to 5, preferably from 0.1 to 1% by weight, based on the monomers used in the polymerization. The chain-transfer agents are preferably metered in together with the monomers. However, they may also be partly or completely present in the initially taken mixture. They can also be metered in stepwise at different times from the monomers.

Initiators which form free radicals under the reaction conditions are usually used in the emulsion polymerization. The initiators are used, for example, in amounts of up to 2% by weight, preferably at least 0.9% by weight, e.g. from 1.0 to 1.5% by weight, based on the monomers to be polymerized. Suitable polymerization initiators are, for example, peroxides, hydroperoxides, hydrogen peroxide, sodium or potassium persulfate, redox catalysts and azo compounds, such as 2,2-azobis(4-methoxy-2,4-dimethylvaleronitrile), 2,2-azobis(2,4-dimethylvaleronitrile) and 2,2-azobis(2-amidinopropane) dihydrochloride. Examples of further suitable initiators are dibenzoyl peroxide, tert-butyl perpivalate, tert-butyl-per-2-ethylhexanoate, di-tert-butyl peroxide, diamyl peroxide, dioctanoyl peroxide, didecanoyl peroxide, dilauroyl peroxide, bis(o-toluoyl) peroxide, succinyl peroxide, tert-butyl peracetate, tert-butyl permaleate, tert-butyl perisobutyrate, tert-butyl perpivalate, tert-butyl peroctanoate, tert-butyl perbenzoate, tert-butyl hydroperoxide, azobisisobutyronitrile, 2,2″-azobis(2-methylbutyronitrile), 2,2″-azobis(2,4-dimethylvaleronitrile) and 2,2″-azobis(N,N″-dimethyleneisobutyroamidine) dihydrochloride. Initiators are preferably selected from the group consisting of the peroxodisulfates, peroxosulfates, azo initiators, organic peroxides, organic hydroperoxides and hydrogen peroxide. Water-soluble initiators, e.g. sodium persulfate, potassium persulfate, ammonium persulfat, sodium peroxodisulfate, potassium peroxodisulfate and/or ammonium peroxodisulfate, are preferably used. The polymerization can also be initiated with the aid of high-energy beams, such as electron beams, or by irradiation with UV light.

In an embodiment of the invention, the initiators are used in amounts of at least 1.2% by weight for further reduction of the arylcyclohexene content.

Effecting the emulsion polymerization in at least two stages has proven particularly advantageous for avoiding high contents of arylcyclohexenes, the beginning of the addition of the monomeric vinylaromatic compound (A) taking place at a different time from the beginning of the addition of the monomeric conjugated aliphatic diene. Preferably, at least part of the monomeric vinylaromatic compounds, e.g. at least 3.5% by weight of the total amount of all monomeric vinylaromatic compounds, is initially taken under polymerization conditions in the aqueous medium or added to the polymerization mixture before the addition of monomeric conjugated aliphatic dienes is started.

The invention therefore also relates to a process for the preparation of arylcyclohexene-free or low-arylcyclohexene aqueous polymer dispersions from at least three different monomer types (A) to (C),

(A) at least one monomeric vinylaromatic compound,
(B) at least one monomeric conjugated aliphatic diene and
(C) at least one monomeric ethylenically unsaturated acid
being copolymerized in aqueous emulsion,
the copolymerization of the monomers being initiated by free radicals and being effected in the presence of at least one molecular weight regulator,
at least one mercaptoalkylcarboxylic acid ester of a C₂- to C₄-carboxylic acid being used as the molecular weight regulator,
no or substantially no alkyl mercaptan being used as the molecular weight regulator and
the emulsion polymerization being effected in at least two stages,
the beginning of the addition of the monomeric vinylaromatic compound (A) taking place at a different time from the beginning of the addition of the monomeric conjugated aliphatic diene (B).

Preferably, at least part of the monomeric vinylaromatic compounds are initially taken under polymerization conditions in the aqueous medium or added to the polymerization mixture before the addition of monomeric conjugated aliphatic dienes is started. According to the invention, this means that in any case no substantial amounts of monomeric conjugated aliphatic dienes are present in the polymerization mixture at the beginning of the polymerization reaction. Substantial amounts are those amounts which lead to a substantial amount (>90 ppm) of arylcyclohexene as by-products in the polymerization. Polymerization mixture is the mixture of initially taken monomers or monomers added to the polymerization vessel and polymer already formed.

In a preferred embodiment of the process according to the invention, at least 5% by weight, preferably from 7 to 30% by weight, of the total amount of all monomeric vinylaromatic compounds are present in the polymerization mixture under polymerization conditions and preferably have already been polymerized before the addition of monomeric conjugated aliphatic dienes is started. The remaining monomers are then metered together or separately from one another into the initially taken mixture under polymerization conditions. Under polymerization conditions is to be understood as meaning that the reaction mixture in the receiver has been heated to the required temperature at which the polymerization takes place. These temperatures are, for example, from 80 to 130° C., preferably from 85 to 120° C. The polymerization is preferably carried out under pressure, for example at pressures up to 15 bar, for example from 2 to 10 bar.

In order to prepare the polymer dispersions according to the invention, a part of the monomers differing from the monomeric conjugated aliphatic dienes (for example from 2 to 10 parts by weight, based on the total amount of monomers), a part of the initiators (for example from 2 to 10 parts by weight, based on the total amount of initiators), a part of the chain-transfer agents (for example from 2 to 10 parts by weight, based on the total amount of chain-transfer agents) and, if appropriate, polymer seed are initially taken, for example in a heatable reactor which is equipped with a mixing apparatus, and heated under polymerization conditions, and the remaining monomers, initiators and chain-transfer agents are allowed to run in together or separately.

In order to promote the dispersing of the monomers in the aqueous medium, the protective colloids and/or emulsifiers usually employed as dispersants can be used. A detailed description of suitable protective colloids is to be found in Houben-Weyl, Methoden der organischen Chemie, volume XIV/1, Makromolekulare Stoffe, Georg-Thieme-Verlag, Stuttgart, 1961, pages 411 to 420. Suitable emulsifiers are surface-active substances whose number average molecular weight is usually below 2000 g/mol or preferably below 1500 g/mol, while the number average molecular weight of the protective colloids is above 2000 g/mol, for example from 2000 to 100 000 g/mol, in particular from 5000 to 50 000 g/mol.

Suitable emulsifiers are, for example, ethoxylated C₈- to C₃₆-fatty alcohols having a degree of ethoxylation of from 3 to 50, ethoxylated mono-, di- and tri-C₄- to C₁₂-alkylphenols having a degree of ethoxylation of from 3 to 50, alkali metal salts of dialkyl esters of sulfosuccinic acid, alkali metal and ammonium salts of C₈- to C₁₂-alkylsulfates, alkali metal and ammonium salts of C₁₂- to C₁₈-alkylsulfonic acids and alkali metal and ammonium salts of C₉- to C₁₈-alkylarylsulfonic acids. Cationic emulsifiers are, for example, compounds having at least one amino or ammonium group and at least one C₈-C₂₂-alkyl group. If emulsifiers and/or protective colloids are concomitantly used as assistants for dispersing the monomers, the amounts thereof which are used are, for example, from 0.1 to 5% by weight, based on the monomers.

Suitable protective colloids are, for example, degraded starch, in particular maltodextrin. All native starches, such as starches from corn, wheat, oats, barley, rice, millet, potatoes, peas, tapioca, sorghum or sago are suitable as starting starches for the preparation of the degraded starches. Also of interest are those natural starches which have a high amylopectin content, such as waxy corn starch and waxy potato starch. The amylopectin content of these starches is above 90%, in general from 95 to 100%. Starches chemically modified by etherification or esterification can also be used for the preparation of the polymer dispersions according to the invention. Such products are known and are commercially available. They are prepared, for example, by esterification of native starch or degraded native starch with inorganic or organic acids or their anhydrides or chlorides. Of particular interest are phosphated and acetylated degraded starches. The most common method for the etherification of starches consists in the treatment of starch with organic halogen compounds, epoxides or sulfates in aqueous alkaline solution. Known starch ethers are alkyl ethers, hydroxyalkyl ethers, carboxyalkyl ethers and allyl ethers. The reaction products of starches with 2,3-epoxypropyltrimethylammonium chloride are also suitable. Degraded native starches, in particular native starches degraded to give maltodextrin, are particularly preferred. Further suitable starches are cationically modified starches, i.e. starch compounds which have amino groups or ammonium groups. The degraded starches have, for example, an intrinsic viscosity ηi of less than 0.07 dl/g or less than 0.05 dl/g. The intrinsic viscosity ηi of the degraded starches is preferably in the range from 0.02 to 0.06 dl/g. The intrinsic viscosity ηi is determined according to DIN EN1628 at a temperature of 23° C.

In an embodiment of the invention, the emulsion polymerization is effected in the presence of seed particles for further reduction of the arylcyclohexene content. The initially taken mixture then comprises polymer seed, in particular one polymer seed, i.e. an aqueous dispersion of finely divided polymer, preferably polystyrene, having a particle diameter of from 20 to 40 nm.

The emulsion polymerization is effected in an aqueous medium. This may be, for example, demineralized water or mixtures of water and a solvent miscible therewith, such as methanol, ethanol or tetrahydrofuran. As soon as the polymerization temperature desired in each case has been reached, or within a time span of from 1 to 15 minutes, preferably from 5 to 15 minutes, after the polymerization temperature has been reached, the metering of the monomers is begun. They can be pumped into the reactor for example, continuously in the course of, for example, from 60 minutes to 10 hours, in general within from 2 to 4 hours.

At least with respect to the monomeric conjugated aliphatic dienes, a stepwise addition is effected relative to the vinylaromatic monomers. At least part of the vinylaromatic monomers is initially taken or metered into the initially taken mixture before the addition of the monomeric conjugated aliphatic dienes is begun.

In a preferred embodiment, at least 5, particularly preferably at least 7 or at least 10% by weight, based on the total amount of all vinylaromatic monomers, of vinylaromatic monomers are initially taken in the aqueous medium under polymerization conditions and/or are added to the polymerization mixture under polymerization conditions before the addition of monomeric conjugated aliphatic dienes is started. For example, at least 1, particularly preferably at least 3 or at least 5% by weight of the monomers can be initially taken before the feed of the remaining monomers is started. At the beginning of the addition of monomeric conjugated aliphatic dienes, the polymerization mixture preferably consists of at least 5, preferably at least 7 or at least 10 parts by weight of already formed polymer. In particular, preferably at least 5, particularly preferably at least 7 or at least 10% by weight of the monomers (A), (C) and (D) differing from monomeric conjugated aliphatic dienes (B), in particular styrene and ethylenically unsaturated acid monomers, have already polymerized before the addition of monomeric conjugated aliphatic dienes is begun.

In the polymer particles produced according to the invention, conjugated aliphatic dienes, in particular units derived from butadiene, are presumably present predominantly on the surface or in an outer layer of the polymer particles. The core of the polymer particles presumably has a lower concentration of units derived from conjugated aliphatic dienes than the shell.

Stepwise addition of the other monomers is also possible, in particular stepwise addition of the monomers (D).

In a preferred embodiment of the process according to the invention, from 1 to 10% by weight of the monomers (A), (C) and (D) to be polymerized altogether are initially taken. The monomers are initially taken in the reactor preferably together with further constituents (e.g. polymer seed, emulsifiers, protective colloids, in each case from 1 to 10% by weight of the respective total amount of initiators and molecular weight regulators), the reactor content is then heated to the polymerization temperature and the remaining monomers are then metered in as stated above. According to the invention, no conjugated aliphatic diene monomers are present in the initially taken monomers. This means, according to the invention, that in any case no substantial amounts of conjugated aliphatic diene monomers are present. Substantial amounts are those amounts which lead in the polymerization to a substantial amount of arylcyclohexenes, in particular to 90 ppm or more of arylcyclohexenes.

After the end of the polymerization, it is possible, if appropriate, to add further initiator to the reaction mixture and to carry out a postpolymerization at the same temperature as or a lower or higher temperature than in the case of the main polymerization. In order to complete the polymerization reaction, it is sufficient in most cases to stir the reaction mixture after addition of all monomers, for example, for a further 1 to 3 hours at the polymerization temperature. The pH may be, for example, from 1 to 5 during the polymerization. After the polymerization, the pH is adjusted, for example, to a value of from 6 to 7. Low-arylcyclohexene aqueous dispersions are obtained. The amount of arylcyclohexene is in the ppm range and is preferably less than 90 ppm, in particular less than 80 ppm.

An aqueous polymer dispersion whose dispersed particles have an average particle diameter of, preferably, from 80 to 150 nm is obtained. The average particle diameter of the polymer particles can be determined by dynamic light scattering on a 0.005 to 0.01% strength by weight aqeuous polymer dispersion at 23° C. with the aid of an Autosizer IIC from Malvern Instruments, England. The data are based in each case on the average diameter of the cumulant evaluation (cumulant z-average) of the meaured autocorrelation function according to ISO standard 13321.

In an embodiment, the solids content of the aqueous polymer dispersion according to the invention is from 40 to 60% by weight. The solids content can be established, for example, by appropriate adjustment of the amount of water and/or of the amount of monomers used in the emulsion polymerization.

In a preferred embodiment, the aqueous polymer dispersion is prepared by the above-described stepwise polymerization with addition of the monomeric conjugated aliphatic dienes at a different time in the presence of polymer seed and with an amount of at least 1% by weight of initiator.

The aqueous polymer dispersions according to the invention are used as a binder, adhesive, size for fibers, for the production of coverings or for the preparation of paper coating slips. The aqueous polymer dispersions according to the invention are suitable both for the sizing of textile fibers and for the sizing of mineral fibers, in particular glass fibers. Owing to their good adhesive power, in particular with the use of comonomers which lead to a low glass transition temperature of the copolymer (e.g. less than 20° C.), they can also be used as an adhesive and for the production of coverings. The aqueous polymer dispersions according to the invention are preferably used as binders in paper coating slips and as binders for fibers, in particular for textile fibers.

The invention therefore also relates to a paper coating slip comprising (i) inorganic pigments and (ii) an aqueous polymer dispersion described above and obtainable by the process according to the invention and, if appropriate, further additives.

Paper coating slips comprise, in addition to water, in general pigments, binders and assistants for establishing the required rheological properties, e.g. thickeners. The pigments are usually dispersed in water. The paper coating slip comprises pigments in an amount of, preferably, at least 80% by weight, e.g. from 80 to 95% by weight or from 80 to 90% by weight, based on the total solids content. White pigments are particularly suitable. Suitable pigments are, for example, metal salt pigments, such as, for example, calcium sulfate, calcium aluminate sulfate, barium sulfate, magnesium carbonate and calcium carbonate, of which carbonate pigments, in particular calcium carbonate, are preferred. The calcium carbonate may be natural ground calcium carbonate (GCC), precipitated calcium carbonate (PCC), lime or chalk. Suitable calcium carbonate pigments are available, for example, as Covercarb® 60, Hydrocarb® 60 or Hydrocarb® 90 ME. Further suitable pigments are, for example, silicic acids, aluminum oxides, aluminum hydroxide, silicates, titanium dioxide, zinc oxide, kaolin, alumina, talc or silicon dioxide. Suitable further pigments are available, for example, as Capim® MP 50 (clay), Hydragloss® 90 (clay) or Talcum C10.

The paper coating slips comprise at least one binder. The polymer dispersion prepared according to the invention can be used in the paper coating slip as the sole binder or in combination with further binders. The most important tasks of binders in paper coating slips are to bind the pigments to the paper and the pigments to one another and partly to fill cavities between pigment particles. For example, from 1 to 50 parts by weight, preferably from 1 to 25 parts by weight or from 5 to 20 parts by weight of an organic binder (solid, i.e. without water or other solvents which are liquid at 21° C., 1 bar) are used per 100 parts by weight of pigments.

Suitable further binders are binders having a natural base, in particular starch-based binders, and synthetic binders differing from the polymers prepared according to the invention, in particular emulsion polymers which can be prepared by emulsion polymerization. In this context, starch-based binders are to be understood as meaning any native, modified or degraded starch. Native starches may consist of amylose, amylopectin or mixtures thereof. Modified starches may be oxidized starch, starch esters or starch ethers. The molecular weight of the starch can be reduced by hydrolysis (degraded starch). Suitable degradation products are oligosaccharides or dextrins. Preferred starches are cereal, corn and potato starch. Cereal and corn starch are particularly preferred and cereal starch is very particulalry preferred.

Further synthetic binders differing from the polymers prepared according to the invention preferably comprise at least 40% by weight, preferably at least 60% by weight, particularly preferably at least 80% by weight, of so-called main monomers. The main monomers are selected from C₁-C₂₀-alkyl (meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds or mixtures of these monomers. For example, alkyl (meth)acrylates having a C₁-C₁₀-alkyl radical, such as methyl methacrylate, methyl acrylate, n-butyl acrylate, ethyl acrylate and 2-ethylhexyl acrylate, may be mentioned.

In particular, mixtures of the alkyl (meth)acrylates are also suitable. Vinyl esters of carboxylic acids having 1 to 20 carbon atoms are, for examplem vinyl laurate, vinyl stearate, vinyl propionate, vinyl versatate and vinyl acetate. Suitable vinylaromatic compounds are vinyltoluene, a- and p-methylstyrene, a-butylstyrene, 4-n-butylstyrene, 4-n-decylstyrene and preferably styrene. Examples of nitriles are acrylonitrile and methacrylonitrile. The vinyl halides are ethylenically unsaturated compounds substituted by chlorine, fluorine or bromine, preferably vinyl chloride and vinylidene chloride. For example, vinyl methyl ether or vinyl isobutyl ether may be mentioned as vinyl ethers. Vinyl ethers of alcohols comprising 1 to 4 carbon atoms are preferred. Ethylene, propylene, butadiene, isoprene and chloroprene may be mentioned as hydrocarbons having 2 to 8 carbon atoms and one or two olefinic double bonds. Preferred main monomers are C₁-C₁₀-alkyl (meth)acrylates and mixtures of the alkyl (meth)acrylates with vinylaromatics, in particular styrene, or hydrocarbons having 2 double bonds, in particular butadiene, or mixtures of such hydrocarbons with vinylaromatics, in particular styrene. In the case of mixtures of aliphatic hydrocarbons (in particular butadiene) with vinylaromatics (in particular styrene), the ratio may be, for example, from 10:90 to 90:10, in particular from 20:80 to 80:20. Particularly preferred main monomers are butadiene and the above mixtures of butadiene and styrene.

In addition to the main monomers, the emulsion polymer suitable as binder may comprise further monomers, for example monomers having carboxyl, sulfo or phosphonic acid groups. Carboxyl groups are preferred. For example, acrylic acid, methacrylic acid, itaconic acid, maleic acid or fumaric acid may be mentioned. The content of ethylenically unsaturated acids in the emulsion polymer is in general less than 10% by weight, preferably less than 8% by weight and at least 0.1% by weight or at least 1% by weight. Further monomers are, for example, also monomers comprising hydroxyl groups, in particular C₁-C₁₀-hydroxyalkyl (meth)acrylates, or amides such as (meth)acrylamide.

When synthetic binders are used, natural binders, such as starch, can also be concomitantly used but are not absolutely essential. Polymers prepared according to the invention are preferably present as sole synthetic binders.

Paper coating slips according to the invention may additionally comprise further additives and assistants, for example fillers, cobinders and thickeners for further optimizing viscosity and water retention, optical brighteners, dispersants, surfactants, lubricants (e.g. calcium stearate and waxes), neutralizing agents (e.g. NaOH or ammonium hydroxide) for pH adjustment, antifoams, deaerating agents, preservatives (e.g. biocides), leveling agents, dyes (in particular soluble dyes), etc. Suitable thickeners in addition to synthetic polymers (e.g. crosslinked polyacrylate) are in particular celluloses, preferably carboxymethylcellulose. Optical brighteners are, for example, fluorescent or phosphorescent dyes, in particular stilbenes.

The paper coating slip is preferably an aqueous paper coating slip; it comprises water in particular through the formulation form of the constituents itself (aqueous polymer dispersions, aqueous pigment slurries); the desired viscosity can be established by addition of further water. Customary solids contents of the paper coating slips are in the range from 30 to 70% by weight. The pH of the paper coating slip is preferably adjusted to values of from 6 to 10, in particular from 7 to 9.5.

An embodiment of the invention relates to a paper coating slip, the polymers of the aqueous polymer dispersion prepared according to the invention being used in an amount of from 1 to 50 parts by weight, based on the total amount of pigments, and the pigments being present in an amount of from 80 to 95 parts by weight, based on the total solids content, and being selected from the group consisting of calcium sulfate, calcium aluminate sulfate, barium sulfate, magnesium carbonate, calcium carbonate, silicic acids, aluminum oxides, aluminum hyhdroxide, silicates, titanium dioxide, zinc oxide, kaolin, alumina, talc and silicon dioxide, and the paper coating slip additionally comprising at least one assistant selected from the group consisting of thickeners, further polymeric binders, cobinders, optical brighteners, fillers, leveling agents, dispersants, surfactants, lubricants, neutralizing agents, antifoams, deaerating agents, preservatives and dyes.

The invention also relates to paper or cardboard coated with a paper coating slip according to the invention and to a process for coating paper or cardboard,
an aqueous polymer dispersion being prepared according to the invention or being provided; and
a paper coating slip being prepared with this polymer dispersion, at least one pigment and optional further assistants; and the paper coating slip being applied to at least one surface of paper or cardboard.

The paper coating slip is preferably applied to uncoated base paper or uncoated cardboard. The amount is in general from 1 to 50 g, preferably from 5 to 30 g (solid, i.e. without water or other solvents which are liquid at 21° C., 1 bar) per square meter. The coating can be effected by customary application methods, for example by means of a size press, film press, blade coater, air brush, knife coater, curtain coating process or spray coater. Depending on the pigment system, the aqueous dispersions of the water-soluble copolymers in paper coating slips can be used for the basecoat and/or for the topcoat.

In the preparation process according to the invention, formation of arylcyclohexenes is substantially suppressed. Paper coating slips according to the invention have good performance characteristics. They have good running behavior in paper coating processes and a high binding power. The coated papers and cardboards have good surface strength, in particular very high wet and dry pick resistance. They can be printed on with good results in the customary printing processess, such as relief printing, gravure printing, offset printing, digital printing, inkjet printing, flexographic printing, newspaper printing, letterpress printing, sublimation printing, laser printing, electrophotographic printing and a combination of these printing processes.

### EXAMPLES

Unless evident otherwise from the context, the data in percent are always percent by weight. The statement of a content relates to the content in aqueous solution or dispersion.

The solids contents are determined by drying a defined amount of the respective aqueous copolymer dispersion (about 5 g) at 140° C. in a drying oven to constant weight. In each case two separate measurements are carried out and the mean value is calculated.

The determination of the glass transition temperature is effected according to DIN 53765 by means of a DSC820 apparatus, series TA8000, from Mettler-Toledo Int. Inc.

The amount of 4-phenylcyclohexene (4-PCH) is determined by gas chromatography.

The average particle diameters of the polymer particles are determined by dynamic light scattering on a 0.005 to 0.01% strength by weight aqueous polymer dispersion at 23° C. by means of an Autosizer IIC of Malvern Instruments, England. The average diameter of cumulant evaluation (cumulant z-average) of the measured autocorrelation function is stated (ISO standard 13321).

### Example 1 (Comparative Example)

### Tert-Dodecyl Mercaptan as Molecular Weight Regulator

700 g of deionized water, 82 g of polystyrene latex (30 nm) and in each case 5% by weight of feeds 1A and 1B were initially taken at room temperature and under a nitrogen atmosphere in a 6 I pressurized reactor equipped with an MIG stirrer and 3 metering apparatuses. Thereafter, the reactor content was heated to 90° C. with stirring (180 rpm) and, on reaching 85° C., 57 g of a 7% strength by weight aqueous sodium persulfate solution were added. After 10 minutes, beginning at the same time, the remaining amount (in each case 95%) of feed 1A and feed 1B was metered in in the course of 360 minutes and feed 2 in the course of 390 minutes, continuously at constant flow rates. Over the total metering time, the streams of feed 1A and feed 1B were homogenized shortly before entry into the reactor. Thereafter, the reactor content was allowed to continue reacting for a further 2 hours at 90° C. Thereafter, the reactor content was cooled to room temperature and adjusted to a pH of 6.5 with a 15% strength by weight aqueous NaOH solution and the pressurized container was let down to atmospheric pressure.

### Feed 1A

Homogeneous mixture of

| | | |
|---|---|---|
| 535 | g | of deionized water |
| 51 | g | of a 15% strength by weight aqueous sodium |
| | | dodecylsulfate solution |
| 95 | g | of acrylic acid |

### Feed 1B

Homogeneous mixture of

| | | |
|---|---|---|
| 1092 | g | of styrene |
| 23 | g | of tert-dodecyl mercaptan |
| 900 | g | of 1,3-butadiene |

### Feed 2

| | |
|---|---|
| 450 g | of a 3.5% strength by weight aquesous sodium persulfate solution |

The aqueous dispersion (D1) obtained had a solids content of 52% by weight, based on the total weight of the aqueous dispersion. The glass transition temperature was determined as −6° C. and the particle size as 142 nm.

4-PCH content: 50 ppm

### Example 2 (Comparative Example)

### Mercaptoethyl Propionate as Molecular Weight Regulator

Standard process: immediate butadiene addition

700 g of deionized water, 82 g of polystyrene latex (30 nm) and in each case 5% by weight of feeds 1A and 1B were initially taken at room temperature and under a nitrogen atmosphere in a 6 I pressurized reactor equipped with an MIG stirrer and 3 metering apparatuses. Thereafter, the reactor content was heated to 90° C. with stirring (180 rpm) and, on reaching 85° C., 57 g of a 7% strength by weight aqueous sodium persulfate solution were added. After 10 minutes, beginning at the same time, the remaining amount (in each case 95%) of feed 1A and feed 1B was metered in in the course of 360 minutes and feed 2 in the course of 390 minutes, continuously at constant flow rates. Over the total metering time, the streams of feed 1A and feed 1B were homogenized shortly before entry into the reactor. Thereafter, the reactor content was allowed to continue reacting for a further 2 hours at 90° C. Thereafter, the reactor content was cooled to room temperature and adjusted to a pH of 6.5 with a 15% strength by weight aqueous NaOH solution and the pressurized container was let down to atmospheric pressure.

### Feed 1A

Homogeneous mixture of

| | | |
|---|---|---|
| 520 | g | of deionized water |
| 51 | g | of a 15% strength by weight aqueous sodium |
| | | dodecylsulfate solution |
| 95 | g | of acrylic acid |

### Feed 1B

Homogeneous mixture of

| | | |
|---|---|---|
| 1092 | g | of styrene |
| 8 | g | of 2-mercaptoethyl propionate |
| 900 | g | of 1,3-butadiene |

### Feed 2

| | |
|---|---|
| 450 g | of a 3.5% strength by weight aqueous sodium persulfate solution |

The aqueous dispersion (D2) obtained had a solids content of 51.8% by weight, based on the total weight of the aqueous dispersion. The glass transition temperature was determined as −6° C. and the particle size as 141 nm.

4-PCH content: 107 ppm

### Example 3

### Mercaptoethyl Propionate as Molecular Weight Regulator, Stepwise Polymerization

700 g of deionized water, 82 g of polystyrene latex (30 nm) and in each case 5% by weight of feeds 1A and 1B were initially taken at room temperature and under a nitrogen atmosphere in a 6 I pressurized reactor equipped with an MIG stirrer and 3 metering apparatuses. Thereafter, the reactor content was heated to 90° C. with stirring (180 rpm) and, on reaching 85° C., 60 g of a 7% strength by weight aqueous sodium persulfate solution were added. After 10 minutes, beginning at the same time, the remaining amount (in each case 95%) of feed 1A and feed 1B was metered in in the course of 360 minutes and feed 2 in the course of 390 minutes, continuously at constant flow rates. 30 min after the start of feeds 1A and 1 B, feed 1C was started. Over the total metering time, the streams of feed 1A and feed 1B were homogenized shortly before entry into the reactor. Thereafter, the reactor content was allowed to continue reacting for a further 2 hours at 90° C. Thereafter, the reactor content was cooled to room temperature and adjusted to a pH of 6.5 with a 15% strength by weight aqueous NaOH solution and the pressurized container was let down to atmospheric pressure.

### Feed 1A

Homogeneous mixture of

| | | |
|---|---|---|
| 537 | g | of deionized water |
| 51 | g | of a 15% strength by weight aquous sodium |
| | | dodecylsulfate solution |
| 95 | g | of acrylic acid |

### Feed 1B

Homogeneous mixture of

| | | |
|---|---|---|
| 1092 | g | of styrene |
| 8 | g | of 2-mercaptoethyl propionate |

### Feed 1C

| | |
|---|---|
| 900 g | of 1,3-butadiene |

### Feed 2

| | |
|---|---|
| 540 g | of a 3.5% strength by weight aqueous sodium persulfate solution |

The aqueous dispersion (D3) obtained had a solids content of 50.1% by weight, based on the total weight of the aqueous dispersion. The glass transition temperature was determined as −6° C. and the particle size as 142 nm.

4-PCH content: 63 ppm

### Example 4

### Mercaptoethyl Propionate as Molecular Weight Regulator, Stepwise Polymerization

700 g of deionized water, 97 g of polystyrene latex (30 nm) and in each case 5% by weight of feeds 1A and 1B were initially taken at room temperature and under a nitrogen atmosphere in a 6 I pressurized reactor equipped with an MIG stirrer and 3 metering apparatuses. Thereafter, the reactor content was heated to 90° C. with stirring (180 rpm) and, on reaching 85° C., 60 g of a 7% strength by weight aqueous sodium persulfate solution were added. After 10 minutes, beginning at the same time, the remaining amount (in each case 95%) of feed 1A and feed 1B was metered in in the course of 360 minutes and feed 2 in the course of 390 minutes, continuously at constant flow rates. 30 min after the start of feeds 1A and 1 B, feed 1C was started.

Over the total metering time, the streams of feed 1A and feed 1B were homogenized shortly before entry into the reactor. Thereafter, the reactor content was allowed to continue reacting for a further 2 hours at 90° C. Thereafter, the reactor content was cooled to room temperature and adjusted to a pH of 6.5 with a 15% strength by weight aqueous NaOH solution and the pressurized container was let down to atmospheric pressure.

### Feed 1A

Homogeneous mixture of

| | | |
|---|---|---|
| 537 | g | of deionized water |
| 51 | g | of a 15% strength by weight aqueous sodium |
| | | dodecylsulfate solution |
| 95 | g | of acrylic acid |

### Feed 1B

Homogeneous mixture of

| | | |
|---|---|---|
| 1092 | g | of styrene |
| 8 | g | of 2-mercaptoethyl propionate |

### Feed 1C

| | |
|---|---|
| 900 g | of 1,3-butadiene |

### Feed 2

| | |
|---|---|
| 540 g | of a 3.5% strength by weight sodium persulfate solution |

The aqueous dispersion (D4) obtained had a solids content of 50% by weight, based on the total weight of the aqueous dispersion. The glass transition temperature was determined as −5° C. and the particle size as 138 nm.

4-PCH content: 49 ppm

The aqueous polymer dispersions D1 to D4 prepared according to the examples are used as binders for paper coating slips.

### Preparation of the Paper Coating Slips:

The coating slip is prepared in a stirred unit into which the individual components are fed in succession. The pigments are added in predispersed form (slurry). The other components are added after the pigments, the sequence corresponding to the sequence in the stated coating slip formulation. The final solids content is established by addition of water.

### Coating Slip Formulation:

70 parts of finely divided carbonate (Hydrocarb 90, Omya)
30 parts of finely divided clay (Hydragloss 90, Omya)
10 parts of coating slip binder (emulsion polymers of Examples 1-4)
0.5 part of rheology assistant (carboxymethylcellulose)

The coating slip is applied to one side of a coating paper by means of a laboratory coating machine and dried by means of IR radiators. The weight of the applied coat is about 10 g/m².

The coated paper was investigated with regard to the surface strength by test methods known to the person skilled in the art. The following test methods were used:

IGT dry pick resistance
IGT wet pick resistance
The results are summarized in the following table.
Dry Pick Resistance with the IGT Proof Printer (IGT Dry)

Strips were cut from the papers to be tested and were printed on using the IGT proof printer. Printing inks used are special test inks from Lorillieux, which transmit different tensile forces. The test strips are passed with continuously increasing speed (maximum speed 200 cm/s) through the printing unit. In the evaluation, the location where 10 picks from the paper surface (pick points) have occurred after printing has started is determined on the proof strip. The speed in cm/sec which was present at this location during printing and the test ink used are stated as a measure of the dry pick resistance. The higher this printing speed at the tenth pick point, the better the rating of the quality of a paper surface.

Wet Pick Resistance with the IGT Proof Printer (IGT Wet)

Strips were cut from the papers to be tested and were printed on using the IGT proof printer. The printer was set up so that the test strips are moistened with water before the printing process. Printing inks used are special test inks from Lorillieux which transmit different tensile forces. The printing is carried out at a constant speed of 0.6 cm/s. Picks from the paper surface are visible as unprinted areas. For determining the wet pick resistance, the ink density is determined using an ink densitometer in comparison with a solid hue in %. The higher the stated ink density, the better the wet pick resistance.

### Odor Test

The products were also assessed by a trained group of persons with regard to the odor. The procedure in such odor tests is known to the person skilled in the art. The odor level of the samples was rated on a scale from 1 to 6, where 1=very good and 6=very poor.

| | Dry pick | Wet pick | | 4-PCH |
|---|---|---|---|---|
| | resistance in cm/s | resistance in % | Odor | content |
| Example 1 | 131 | 47 | 4 | 50 |
| (comparison) | | | | |
| Example 2 | 139 | 54 | 2 | 107 |
| (comparison) | | | | |
| Example 3 | 142 | 61 | 3 | 63 |
| Example 4 | 140 | 69 | 3 | 49 |

Examples 3 and 4 have a significantly better odor than Comparative Example 1 comprising alkyl mercaptan, with a tendency to better pick resistance and comparable 4-PCH content.

Examples 3 and 4 have a significantly lower 4-PCH content than Example 2 prepared by the standard process.

1. An arylcyclohexene-free or low-arylcyclohexene aqueous polymer dispersion, prepared by free radical emulsion polymerization from at least three different monomers (A) to (C):
(A) at least one monomeric vinylaromatic compound;
(B) at least one monomeric conjugated aliphatic diene; and
(C) at least one monomeric ethylenically unsaturated acid,
copolymerized in an aqueous medium,
in the presence of at least one molecular weight regulator comprising at least one mercaptoalkylcarboxylic acid ester of a C₂- to C₄-carboxylic acid,
wherein substantially no alkyl mercaptan is comprised in the molecular weight regulator, and
wherein a content of arylcyclohexene compounds in the aqueous polymer dispersion is less than 90 ppm.

2. The dispersion of claim 1, wherein
(A) from 19.8 to 80 parts by weight of at least one vinylaromatic compound,
(B) from 19.8 to 80 parts by weight of at least one conjugated aliphatic diene,
(C) from 0.1 to 15 parts by weight of at least one ethylenically unsaturated acid, and
(D) from 0 to 20 parts by weight of at least one further monoethylenically unsaturated monomer differing from the monomers (A) to (C)
are copolymerized, and
wherein a sum of parts by weight of the monomers (A) to (D) is 100.

3. The dispersion of claim 2, wherein the further monomer (D) is present in an amount of 0.1-15 parts by weight and is at least one selected from the group consisting of a C₁- to C₁₈-alkyl esters ester of acrylic acid and a C₁- to C₁₈-alkyl esters ester of methacrylic acid.

4. The dispersion of claim 1, wherein the vinylaromatic compound (A) is at least one selected from the group consisting of styrene and methylstyrene,
wherein the conjugated aliphatic diene (B) is at least one selected from the group consisting of 1,3-butadiene and isoprene, and
wherein the ethylenically unsaturated acid (C) is at least one selected from the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, vinylphosphonic acid, and a salt of any of these acids.

5. The dispersion of claim 1, wherein the molecular weight regulator is a compound of formula (I)
R¹—C(═O)—O—R²—SH (I),
where wherein
R¹ is an alkyl group having 1 to 3 carbon atoms, and
R² is a divalent alkylene group having 1 to 18 carbon atoms.

6. The dispersion of claim 1, wherein the molecular weight regulator is 2-mercaptoethyl propionate.

7. The dispersion of claim 1, wherein the emulsion polymerization is effected in at least two stages, and
wherein a beginning of adding the monomeric vinylaromatic compound (A) takes place at a different time from a beginning of adding the monomeric conjugated aliphatic diene (B).

8. The dispersion of claim 7, wherein at least 5% by weight of a total amount of all monomeric vinylaromatic compounds (A) are initially taken under polymerization conditions in the aqueous medium or are added to a polymerization mixture of the emulsion polymerization before adding monomeric conjugated aliphatic dienes (B).

9. The dispersion of claim 7, wherein the emulsion polymerization is effected in the presence of at least one seed particle.

10. A process for preparing arylcyclohexene-free or low-arylcyclohexene aqueous polymer dispersion, the method comprising copolymerizing at least three different monomers (A) to (C):
(A) at least one monomeric vinylaromatic compound;
(B) at least one monomeric conjugated aliphatic diene; and
(C) at least one monomeric ethylenically unsaturated acid,
in aqueous emulsion,
initiated by free radicals, and being effected in the presence of at least one molecular weight regulator, which comprises at least one mercaptoalkylcarboxylic acid ester of a C₂- to C₄-carboxylic acid being used as the
wherein no aryl mercaptan is comprised in the molecular weight regulator, and
wherein the copolymerizing is an emulsion polymerization effected in at least two stages, in which a beginning of adding the monomeric vinylaromatic compound (A) takes place at a different time from a beginning of adding the monomeric conjugated aliphatic diene (B).

11. The process of claim 10, wherein at least 5% by weight of a total amount of all monomeric vinylaromatic compounds (A) are initially taken under polymerization conditions in the aqueous medium or are added to a polymerization mixture of the emulsion polymerization before the adding of monomeric conjugated aliphatic dienes (B).

12. The process of claim 11, wherein from 7 to 30% by weight of the total amount of all monomeric vinylaromatic compounds (A) are initially taken under polymerization conditions in the aqueous medium or are added to the polymerization mixture before the adding of monomeric conjugated aliphatic dienes (B).

13. The process of claim 10, wherein the emulsion polymerization is effected in the presence of at least one seed particle.

14. The process of claim 10, wherein
(A) from 19.8 to 80 parts by weight of at least one vinylaromatic compound selected from the group consisting of styrene and methylstyrene,
(B) from 19.8 to 80 parts by weight of at least one conjugated aliphatic diene selected from the group consisting of 1,3-butadiene and isoprene,
(C) from 0.1 to 15 parts by weight of at least one ethylenically unsaturated acid selected from the group consisting of acrylic acid, methacrylic acid, itaconic acid, maleic acid, fumaric acid, crotonic acid, vinylacetic acid, vinyllactic acid, vinylsulfonic acid, styrenesulfonic acid, acrylamidomethylpropanesulfonic acid, sulfopropyl acrylate, sulfopropyl methacrylate, vinylphosphonic acid, and a salt of any of these acids, and
(D) from 0 to 20 parts by weight of at least one further monoethylenically unsaturated monomer, differing from the monomers (A) to (C), selected from the group consisting of a C₁- to C₁₈-alkyl ester of acrylic acid and a C₁- to C₁₈-alkyl ester of methacrylic acid
are copolymerized,
wherein a sum of parts by weight of the monomers (A) to (D) is 100.

15. The process of claim 10, wherein the molecular weight regulator is a compound of formula (I)
R¹—C(═O)—O—R²—SH (II)
wherein
R¹ is an alkyl group having 1 to 3 carbon atoms, and
R² is a divalent alkylene group having 1 to 18 carbon atoms.

16. A binder, an adhesive, a size for at least one fiber, a covering, or a paper coating slip, comprising an emulsion polymer obtained from the dispersion of claim 1.

17. A paper coating slip, comprising
(i) at least one inorganic pigment, and
(ii) the aqueous polymer dispersion of claim 1.

18. A paper or cardboard, coated with the paper coating slip of claim 17.

19. The dispersion of claim 1, wherein the vinylaromatic compound (A) comprises styrene.

20. The dispersion of claim 1, wherein the vinylaromatic compound (A) comprises methylstyrene.
